(19) United States
(12) Patent Application Publication
(10) Pub. No.: US 2026/0309190 A1
(43) Pub. Date: Oct. 8, 2026

(54) METHOD FOR MANUFACTURING A HYBRID ROLLING BEARING, AND HYBRID ROLLING BEARING

(71) Applicant: AKTIEBOLAGET SKF, GOTEBORG (SE)

(72) Inventors: Arnaud Matthieu Alain RUELLAN DU CREHU, Malissard (FR); Charlotte Suzanne Peggy VIEILLARD, Woerden (NL); Mehdi MAZAHERI, Amsterdam (NL); Aylin KARAKUSCU, Steyr (AT); Stefan STROBL, Garsten (AT)

(21) Appl. No.: 19/476,311

(22) PCT Filed: Apr. 24, 2023
(86) PCT No.: PCT/EP2023/060658

§ 371 Date: Oct. 17, 2025

(51) Int. Cl. F16C 33/30; F16C 33/32; F16C 33/34; F16C 43/04

(52) U.S. Cl. CPC F16C 33/303; F16C 33/32; F16C 43/04; F16C 33/34; F16C 2237/00

(57) ABSTRACT

Disclosed is a method for manufacturing a hybrid rolling bearing (1), wherein the hybrid rolling bearing (1) comprises at least one set (6) of ceramic rolling elements (4), at least one inner ring (10) made from bearing steel, and at least one outer ring (10) made from bearing steel, wherein the method comprises the following steps disassembling (S3) a used hybrid bearing (1) having at least one set (6) of ceramic rolling elements (4), at least one inner ring (8), and at least one outer ring (8), collecting at least one ceramic rolling element (4) from the set (6) of ceramic rolling elements (4), cleaning (S4) the collected ceramic rolling elements (4), providing at least one mint inner ring (10) made from bearing steel and/or at least one outer ring made from bearing steel (10), selecting (S6) at least one ceramic rolling element (4) of the cleaned ceramic rolling elements (4), assembling (S7) a new hybrid rolling bearing (1) using the at least one selected ceramic rolling element (4), and the at least one mint inner ring (10) made from bearing steel and/or the at least one outer ring (10) made from bearing steel.

### TECHNICAL FIELD OF THE INVENTION

The present invention relates to a method for manufacturing a hybrid rolling bearing. Further, the present invention relates to a hybrid rolling bearing.

### BACKGROUND OF THE INVENTION

Hybrid rolling bearings, which comprise rolling elements made from a ceramic material as well as bearing rings made from steel, are used in an increasing number of applications. Usually the ceramic material used for manufacturing the ceramic rolling elements for a hybrid rolling bearing is silicon nitride (Si₃N₄). However, the production of ceramic rolling elements based on Si₃N₄ powder and sintering additives is highly energy consuming, and the energy consumption and cost per rolling element increases with the diameter of the rolling element. In particular, the ceramic rolling elements can account for a large portion of the final cost of the hybrid bearing.

There is a constant demand for continuous improvements relating to financial costs, energy consumption and/or environmental impact of the production of ceramic rolling elements used in hybrid bearings. In contrast to steel components, which can be re-melted for example, there is currently no method to recycle ceramic rolling elements as raw material. As a consequence, the ceramic rolling elements are usually wasted at the end of service life of the hybrid bearing.

The problem of the current “produce-consume-waste” value chain of ceramic rolling elements has not yet been addressed, although the ceramic rolling elements account for up to 80% of the final cost of the hybrid bearing.

It is therefore object of the present invention, to provide a method for manufacturing a hybrid bearing that allows to reduce the financial cost, energy consumption and/or environmental impact of the ceramic rolling elements used in hybrid bearings.

### SUMMARY OF THE INVENTION

This object is solved by a method for manufacturing a hybrid rolling bearing according to claim 1.

In the following a method for manufacturing a hybrid rolling bearing is provided. The hybrid rolling bearing comprises at least one set of ceramic rolling elements, at least one inner ring made from bearing steel, and at least one outer ring made from bearing steel. The ceramic rolling elements may be made from silicon nitride (Si₃N₄). Furthermore, the inner ring may be provided with an inner raceway and/or the outer ring may be provided with an outer raceway, on which the rolling elements roll. The rolling elements may be balls, cylindrical rollers, tapered rollers, needle rollers, etc. For example, the hybrid rolling bearing may be a hybrid ball bearing. Moreover, the rolling elements may be retained in a cage, wherein the cage is configured to space the rolling elements apart from one another in a circumferential direction.

The method for manufacturing the hybrid rolling bearing comprises the following steps:
disassembling a used hybrid bearing having at least one set of ceramic rolling elements, at least one inner ring made from bearing steel, and at least one outer ring made from bearing steel,
collecting at least one ceramic rolling element from the set of ceramic rolling elements,
cleaning the collected ceramic rolling elements,
providing at least one mint inner ring made from bearing steel and/or at least one mint outer ring made from bearing steel,
selecting at least one ceramic rolling element of the cleaned ceramic rolling elements, and
assembling a new hybrid bearing using the at least one selected ceramic rolling element, and the at least one mint inner ring made from bearing steel and/or the at least one outer ring made from bearing steel.

It has been found that depending on the type of rolling element used in a bearing, the rolling elements may be subjected to more or less wear. In ball bearings for example, the balls are subject to less over-rolling fatigue than the rings due to a random over-rolling direction and spin of the balls in a ball bearing. Furthermore, it has been found that ceramic rolling elements, such as silicon nitride (Si₃N₄) rolling elements, may have very high fatigue limits so that most standard operation condition do not accumulate fatigue in the material, therefore the subsurface material does not fatigue, and the used ceramic rolling elements keep their initial material grade. In other words, the new bearing may be composed of new steel rings that are in mint or unused condition, and already used and re-processed ceramic rolling elements.

Moreover, collecting at least one ceramic rolling element may include collecting one ceramic rolling element of the set of ceramic rolling elements, a part of the at least one set of ceramic rolling elements of the used bearing, or the entire set of ceramic rolling elements. If the used hybrid bearing comprises more than one set of ceramic rolling elements it is also possible to collect only parts of the two sets of ceramic rolling elements or one entire set of ceramic rolling elements and only a part of the other set of ceramic rolling elements or both

In addition, the method may further include a step of providing a mint cage configured retain the ceramic rolling elements. In particular, all steel components and/or parts that are subject to wear such as seals may be replaced with new components and/or parts that are in mint condition.

Thus, the above-mentioned method for manufacturing the hybrid rolling bearing has the advantage that it can be avoided to waste the ceramic rolling elements at the end of service life of a hybrid bearings just because the steel components have been worn out.

Re-using the ceramic rolling elements has the advantage that the financial cost, energy consumption and/or environmental impact of the ceramic rolling elements used in hybrid bearings can be reduced as the largest part of the fore-mentioned impacts for a hybrid bearing are caused by the production of the ceramic rolling elements. More particularly, the problem of the “produce-consume-waste” value chain of ceramic rolling elements may be overcome by introducing circularity of the rolling elements.

The term “used bearing” as used herein may mean a bearing that has been previously used in a machine or application. In particular, a used bearing may have reached its end of service life and may be removed from the machine due to scheduled and/or unscheduled maintenance work. Moreover, at least one steel component of the used bearing such as an inner ring, an inner raceway provided on the inner ring, an outer ring and/or an outer raceway may be worn out.

The term “new bearing” as used herein may mean a bearing that has not yet been used in a machine or application. In particular, a new bearing may be at its begin of service life and may be built into a machine, for example to replace a worn bearing. Moreover, at least one steel component of the new bearing such as an inner ring, an inner raceway provided on the inner ring, an outer ring and/or an outer raceway may be in mint condition.

The method of the invention comprises the several steps. The steps may be executed sequentially. The term “execute sequentially” may mean that the steps are performed in the order in which they are listed. However, the term “execute sequentially” may also encompass the option of including further steps before, after, or in between any of the listed steps.

According to a further embodiment, cleaning the collected ceramic rolling elements includes removing lubricant and/or other particles that may adhere to a surface of the collected ceramic rolling elements and/or that may have accumulated at the surface of the ceramic rolling elements. For example, the lubricant may be a grease, an oil, a lubricating coolant and/or a mixture thereof. Preferably, cleaning the collected ceramic rolling elements includes may comprises a chemical cleaning using chemical cleaning agents configured to remove lubricant and/or other particles.

Furthermore, the method may include a step of re-polishing the collected and/or cleaned ceramic rolling elements. Moreover, re-polishing may be performed using abrasive media, for example diamond, and/or silica, and/or alumina or other oxide-based compounds. Re-polishing the ceramic rolling elements may have the advantage that the accumulated particles and/or other media such as lubricant can be effectively removed.

Preferably, the method further includes a step of inspecting a surface of the ceramic rolling elements to determine a surface appearance class. For example, the surface of the ceramic rolling elements may be inspected with similar techniques that are also applied to new rolling elements. In particular, the surface of the ceramic rolling elements may be inspected with optical methods such as an inspection with white light and/or a fluorescent penetrant inspection. This has the advantage that the surface appearance class of the used ceramic rolling elements can be determined. Additionally, the determined surface appearance class of the used ceramic rolling elements may be compared to the previous surface appearance class of the ceramic rolling elements in mint condition. This may allow to determine whether a surface of a ceramic rolling element has been damaged.

Furthermore, after inspecting the surface of the ceramic rolling elements to determine the surface appearance class, the ceramic rolling elements may be sorted based on the determined surface appearance class. Additionally or alternatively, based on surface performance knowledge and/or specifications, a fitness of the rolling element surface may be evaluated using inspection criteria already in place for new components. For example, the ceramic components may be inspected using interferometry, digital holographic microscopy, X-ray tomography, and the like. Advantageously, due to the hardness, stiffness and/or the main elastic response, the surface of ceramic rolling elements may tend to remain intact or almost as “new”, therefore keeping or almost keeping their initial surface appearance class as well as their diameter tolerance grade.

According to a further embodiment, the method further includes a step of evaluating the ceramic rolling elements based on at least one predetermined criterion. Preferably, the at least one predetermined criterion is a diameter of the ceramic rolling element and/or a quantity indicative of a surface property. The quantity indicative of a surface property may be a surface roughness and/or a surface quality such as surface errors, cavities, and the like. Furthermore, the method may also include a step of sorting the ceramic rolling elements based on the predetermined criterion. For example, the ceramic rolling elements may be sorted based on their diameter. This allows to sort the ceramic rolling elements into sets of rolling elements that have the same diameter.

Preferably, the new ceramic rolling element is selected based on the at least one predetermined criterion. In particular, if a ceramic rolling element passes the required surface appearance class inspection and/or the dimensional requirement it is in shape for prolonged use or in effect for a second service life. More specifically, the reconditioning process such as the aforementioned cleaning process and/or re-polishing process to pass the appearance class inspection may consume at least five times less time and energy compared to the production of a new ceramic rolling element from the Si₃N₄ powder and sintering additives. This may secure lower costs and a much lower environmental footprint via circularity since the extraction of raw material, the manufacturing energy, the quantity of toxic waste, scrap, transport costs, end-of-life waste and/or water consumption can be reduced.

Preferably, the selected new set of ceramic rolling elements is identical or equal to the at least one collected set of ceramic rolling elements of the used hybrid bearing. More particularly, upon disassembly of the used hybrid bearing, the set of ceramic rolling elements can be kept as such. This has the advantage that the step of sorting the ceramic rolling elements based on at least one predetermined criterion can be omitted. That is, due to the hardness, stiffness and/or main elastic response, the surface of the ceramic rolling elements tends to remain intact or almost as “new”, therefore keeping or almost keeping their initial surface appearance class as well as their diameter tolerance grade when kept as a set from a bearing.

According to a further aspect, a hybrid rolling bearing is provided. The hybrid rolling bearing comprises at least one set of ceramic rolling elements, at least one inner ring made from bearing steel, and at least one outer ring made from bearing steel, wherein the hybrid rolling bearing is manufactured according to the above noted method. Preferably, the at least one inner ring made from bearing steel, and/or at least one outer ring made from bearing steel are in mint condition. In addition, the hybrid bearing may further comprise a cage configured to retain the ceramic rolling elements, wherein the cage is in mint condition.

Further preferred embodiments are defined in the dependent claims as well as in the description and the figures. Thereby, elements described or shown in combination with other elements may be present alone or in combination with other elements without departing from the scope of protection.

### BRIEF DESCRIPTION OF THE DRAWINGS

In the following, preferred embodiments of the invention are described in relation to the drawings, wherein the drawings are exemplarily only, and are not intended to limit the scope of protection. The scope of protection is defined by the accompanied claims, only.

The FIGURE shows:

FIG. 1: a schematic illustration of a method for manufacturing a hybrid rolling bearing according to an embodiment.

### DETAILED DESCRIPTION OF THE INVENTION

In the following same or similar functioning elements are indicated with the same reference numerals.

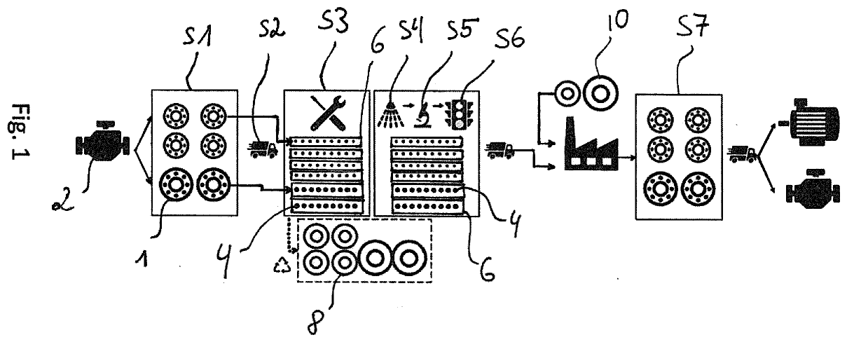

FIG. 1 shows a schematic illustration of a method for manufacturing a hybrid rolling bearing 1 according to an embodiment. The hybrid rolling bearing 1 comprises at least one set of ceramic rolling elements 2, at least one inner and outer ring 8 made from bearing steel. The ceramic rolling elements are balls that are made from silicon nitride (Si₃N₄). Alternatively, the rolling elements may be cylindrical rollers, tapered rollers, needle rollers, etc.

In a first step S1, a customer A collects six hybrid rolling bearings 1 at their respective end of service life from a machine 2. The bearings 1 can then be sent to a service center in step S2. In the next step S3, the hybrid bearings 1 are disassembled and the silicon nitride (Si₃N₄) balls 4 are kept by set and the worn inner and outer ring 8 are recycled.

After disassembling the hybrid bearings 1 and collecting the ceramic balls 4, the ceramic balls 4 are cleaned in a step S4. The cleaning includes a chemical cleaning with chemical cleaning agents to remove the old lubricant. After the cleaning S4, the ceramic balls 4 are re-polished using abrasive media, for example diamond, and/or silica, and/or alumina or other oxide-based compounds to remove any particles that may have accumulated at the surface of the ceramic balls 4.

The cleaned and re-polished ceramic balls 4 are then inspected and/or evaluated based on a predetermined criterion in step S5. The criterion may be a surface appearance class and/or a diameter tolerance grade. For example, the surface of the ceramic balls 4 may be inspected with techniques that are also applied to new rolling elements. For example, the surface of the ceramic balls 4 may be inspected with optical methods such as an inspection with white light and/or a fluorescent penetrant inspection. Additionally or alternatively, the ceramic balls 4 may be inspected using interferometry, digital holographic microscopy, X-ray tomography, and the like.

In a step S6, the ceramic balls 4 are selected based one the at least one predetermined criterion such as the required surface appearance class and/or the diameter tolerance grade and paired with mint inner and outer rings 10 made from bearing steel in step S7 to assemble a new hybrid bearing 1 that is then sold to customer A or B.

In summary, the described method for manufacturing a hybrid rolling bearing solves the problem of the “produce-consume-waste” value chain of ceramic rolling elements by introducing circularity. By re-using already used ceramic rolling elements of known material grade that pass again the surface appearance and/or dimensional requirements for the production of new hybrid bearings, the financial cost, energy consumption and/or environmental impact of the ceramic rolling elements used in hybrid bearings can be reduced.

In particular, the described method may consume at least five times less time and energy compared to the production of a new ceramic rolling element from the Si₃N₄ powder and sintering additives. This may secure the lower costs and a much lower environmental foot-print via circularity due to less extraction of raw material, less manufacturing energy and toxic waste, less scrap, less transport, less end-of-life waste, and/or less water consumption.

Thus, re-using the ceramic rolling elements has the advantage that the financial cost, energy consumption and/or environmental impact of the ceramic rolling elements used in hybrid bearings can be reduced as the largest part of the costs for a hybrid bearing are caused by the production of the ceramic rolling elements.

### REFERENCE NUMERALS

1 hybrid rolling bearing
2 machine
4 rolling elements
6 set of rolling elements
8,10 bearing rings
S1-S7 method steps

1. A method for manufacturing a hybrid rolling bearing, the method comprising the steps of:
disassembling a used hybrid bearing having at least one set of ceramic rolling elements, at least one inner ring, and at least one outer ring,
collecting at least one ceramic rolling element from the at least one set of ceramic rolling elements,
cleaning the at least one collected ceramic rolling element,
providing at least one unused inner ring made from bearing steel and/or at least one unused outer ring made from bearing steel,
selecting at least one ceramic rolling element of the at least one cleaned ceramic rolling element, and
assembling a new hybrid rolling bearing using the at least one selected ceramic rolling element and the at least one unused inner ring and/or the at least one unused outer ring.

2. The method according to claim 1, wherein the step of cleaning the at least one collected ceramic rolling element includes a chemical cleaning.

3. The method according to claim 1 further comprising a step of repolishing the at least one collected ceramic rolling element.

4. The method according to claim 1, further comprising a step of inspecting a surface of the ceramic rolling elements to determine a surface appearance class.

5. The method according to claim 1, further comprising a step of evaluating the ceramic rolling elements based on at least one predetermined criterion.

6. The method according to claim 5, wherein the at least one predetermined criterion is a diameter of the ceramic rolling element and/or a quantity indicative of a surface property of the ceramic rolling element.

7. The method according to claim 6, wherein the at least one selected ceramic rolling element is selected based one the at least one predetermined criterion.

8. The method according to claim 1, further comprising a step of providing an unused cage configured retain ceramic rolling elements

9. The method according to claim 1, wherein the entire set of ceramic rolling elements disassembled from the used hybrid rolling bearing is selected and assembled into the new hybrid rolling bearing.

10. A hybrid rolling bearing comprising:
at least one set of ceramic rolling elements,
at least one inner ring made from bearing steel, and
at least one outer ring made from bearing steel, wherein the hybrid rolling bearing is manufactured according to claim 1.

11. The hybrid rolling bearing according to claim 10, wherein the at least one inner ring made from bearing steel and/or at least one outer ring made from bearing steel are in unused condition.

12. The hybrid rolling bearing according to claim 10, wherein the hybrid rolling bearing further comprises a cage configured to retain the ceramic rolling elements, the cage being in unused condition.
